(19) United States
(12) Patent Application Publication
(10) Pub. No.: US 2014/0146736 A1
(43) Pub. Date: May 29, 2014

(54) METHOD OF GROUPING STATIONS IN MULTI-TRANSMISSION

(71) Applicant: ELECTRONICS AND TELECOMMUNICATIONS RESEARCH INSTITUTE, Daejeon (KR)

(72) Inventors: Igor KIM, Daejeon (KR); Jinhyung OH, Daejeon (KR); Gwangzeen KO, Daejeon (KR); Myung Sun SONG, Daejeon (KR)

(73) Assignee: ELECTRONICS AND TELECOMMUNICATIONS RESEARCH INSTITUTE, Daejeon (KR)

(21) Appl. No.: 14/010,760

(22) Filed: Aug. 27, 2013

(30) Foreign Application Priority Data
Nov. 28, 2012 (KR) 10-2012-0136310
May 29, 2013 (KR) 10-2013-0060956

(51) Int. Cl. H04W 4/08

(52) U.S. Cl. CPC H04W 4/08
USPC 370/312

(57) ABSTRACT

An apparatus for grouping a plurality of stations in a multi-transmission environment includes an SNR (Signal to Noise Ratio) measuring unit configured to measure SNR values of the stations existing in the multi-transmission environment. Further, the apparatus includes a grouping unit configured to group the stations into several subgroups depending on the SNR values, wherein a leader is defined in each subgroup. Furthermore, the apparatus includes a control unit configured to determine an MCS (Modulation and Coding Scheme) intended for each subgroup and form different A-MPDU (Aggregated MAC Protocol Data Unit) for each subgroup separately to send to each subgroup in a multicast transmission.

### CROSS-REFERENCE TO RELATED APPLICATIONS

The present invention claims priority of Korean Patent Application No. 10-2012-0136310, filed on Nov. 28, 2012, and Korean Patent Application No. 10-2013-0060956, filed on May 29, 2013, which are incorporated herein by references.

### FIELD OF THE INVENTION

The present invention relates to a MIMO (Multiple Input Multiple Out) system, and more particularly, to an apparatus and method for grouping stations in a multi-transmission environment, which groups multicast receivers in line with a channel quality and uses a per-stream transmission power control and an appropriate MCS (Modulation and Coding Scheme) for each subgroup, thereby llowing an increased efficiency of a down-link frame multicasting and a high fairness between multicast receivers in MU-MIMO wireless WLAN (Wideband Area LAN) environment based on a multicasting.

### BACKGROUND OF THE INVENTION

A WLAN system is one of the technologies most commonly used to deliver multimedia contents to end users. With the development of laptops, smartphones, tablet PCs, and the like, the demand to access the WLAN at a high speed has greatly increased because of its low cost, high speed and ease of installation. In addition, the growth of the number of active users increases the density of the WLAN network. In this situation, the amount of available resources is very essential to deliver the multimedia contents considering QoS (Quality of Service).

A multicasting is an effective technique that transfers data since it allows transmitting the data to multiple destinations at once, thereby saving network resources. The multicasting is especially suitable for wireless environment where all the recipients of the multicast data share transmission medium. However, the multicast technology suffers from many obstacles in a WLAN environment.

For example, the IEEE 802.11 standard specifies to transmit all of multicast frames in a broadcasting scheme. It is also known that broadcast frames do not require acknowledgements that provide an unreliable delivery. In this situation, even a single frame error may cause a loss of data. These are not suitable for applications that require QoS such as a voice over IP (VoIP), video conferencing, IP television (IPTV), etc.

The above-stated standard also specifies that the multicast frames need be transmitted at a minimum physical transmission rate. The transmitting at the minimum data rate adds more reliability since low transmission rates are more robust and channel error resilient compared to high data rates. Even though this can be suitable for noisy channels in case of high SNR channel transmission with low data rate causes significant inefficiency. It can also negatively affect other multicast or unicast data streams since they have to wait longer for the channel access.

The multicasting provides an unreliable delivery in many other WLAN technologies such as HiperLAN or HipreLAN/2, and AlohaNet. This is based on the assumption that there is no automatic repeat request (ARQ) procedure in all of these technologies, which means that every data unit is transmitted only once.

A good example towards higher throughput is the IEEE 802.11n amendment. It allows achieving high throughput (HT) with the theoretical transmission rate of 600 Mbps. It also firstly described the frame aggregation concept for overhead reduction. The frame aggregation may be defined in two technologies: an aggregated MAC service data unit, A-MSDU) and an aggregated MAC protocol data unit, A-MPDU). The A-MSDU has an overhead lower than the A-MPDU aggregation, but is less efficient in a noisy channel environment. Much of conventional proposals for the multicasting in WLAN do not consider the frame aggregation.

As another example, the IEEE 802.11ac Working Group further increases the transmission rate for achieving the very high throughput (VHT). For the first time in the multi-WLAN network, a multi-user support has become enabled through the use of a multi-user MIMO (MU-MINO) technology. Using the MU-MIMO allows a simultaneous downlink transmission of different data for different stations.

The technology also utilizes the frame aggregation, but is not to increase the aggregated data unit at maximum. The performance of the multicasting in this environment has not yet been studied in detail. Therefore, a need exists for research on the performance of the multicast transmission in the MU-MIMO system.

On the other hand, due to the limitations exerted in performing the multicasting in WLAN networks, IEEE 802.11aa, which is a new working group, has been founded. The working group aims at providing robust multimedia delivery over WLAN by improving enhanced distributed channel access (EDCA) mechanism and introducing several ARQ schemes for multicasting. However, these solutions have also problems in terms of scalability and efficiency.

### SUMMARY OF THE INVENTION

In view of the above, the present invention provides an apparatus and method for grouping stations in a multi-transmission environment, an apparatus and method for grouping stations in a multi-transmission environment, which groups multicast receivers in line with a channel quality and uses a per-stream transmission power control and an appropriate MCS (Modulation and Coding Scheme) for each subgroup, thereby allowing an increased efficiency of a down-link frame multicasting and a high fairness between multicast receivers in MU-MIMO wireless WLAN (Wideband Area LAN) environment based on a multicasting.

In accordance with a first aspect of the present invention, there is provided an apparatus for grouping a plurality of stations in a multi-transmission environment. The apparatus includes an SNR (Signal to Noise Ratio) measuring unit configured to measure SNR values of the stations existing in the multi-transmission environment; a grouping unit configured to group the stations into several subgroups depending on the SNR values, wherein a leader is defined in each subgroup; and a control unit configured to determine an MCS (Modulation and Coding Scheme) intended for each subgroup and form different A-MPDU (Aggregated MAC Protocol Data Unit) for each subgroup separately to send to each subgroup in a multicast transmission.

Further, the grouping unit may be configured to determine the leader as a station, among the stations in each subgroup, with the lowest SNR in the subgroup.

Further, the control unit may be configured to determine the MCS that will be applied to the subgroup considering the SNR value of the leader station in the subgroup.

Further, the control unit may be configured to adjust a size of the different A-MPDU for each subgroup such that the transmission of the different A-MPDU is completed at the same time.

Further, the control unit may be configured to adjust a different transmission power on a stream basis separately for each subgroup when transmitting the A-MPDU to the subgroup.

In accordance with a second aspect of the present invention, there is provided a method for grouping a plurality of user stations in a multi-transmission environment. The method includes grouping the stations existing in the multi-transmission environment into several subgroups depending on SNR values that are measured from the respective stations; determining an MCS (Modulation and Coding Scheme) intended for each subgroup; defining a station that becomes a leader of each subgroup; and forming a different A-MPDU (Aggregated MAC Protocol Data Unit) to be transmitted to each subgroup separately such that the different A-MPDU in line with a link quality of the each subgroup; and multicast-transmitting the A-MPDU to the stations in its corresponding subgroup.

Further, the different A-MPDU may be adjusted in its size such that the transmission of the different A-MPDU for each subgroup is completed at the same time.

Further, the determining the MCS may comprise determining the MCS that is applied to the subgroup considering the SNR value of the leader station of in the subgroup.

Further, the defining the station that becomes the leader may comprise: comparing SNR values of the stations in each subgroup; and selecting a station with a lowest SNR value as the leader.

Further, the method may further comprise checking whether a BA (block acknowledgement) is received from the leader station in each subgroup; and defining a leader of the subgroup again when it is checked that the BA is not received.

Further, the method may further comprise, when it is checked that the BA is received, checking whether all the stations in the subgroup successfully receive the A-MPDU; and when it is checked that all the stations do not receive the MPDU successfully, forming a new A-MPDU of the subgroup.

Further, the method may further comprise, when it is checked that a successful reception of all A-MPDUs is made, removing the A-MDPUs in a transmit queue that are waiting to transmit to the subgroups.

As disclosed above, in accordance with the embodiment of the present invention of grouping stations in a multi-transmission environment, the multicast receivers are grouped in line with a channel quality and the transmission power control are used on a stream basis and an appropriate MCS is performed every subgroup, thereby enabling to increase efficiency of a down-link frame multicasting in a MU-MIMO wireless WLAN environment based on a multicasting and maintain fairness between the multicast receivers in a high level.

### BRIEF DESCRIPTION OF THE DRAWINGS

The above and other objects and features of the present invention will become apparent from the following description of the embodiments given in conjunction with the accompanying drawings, in which:

FIG. 1 is a diagram showing a distribution of stations in a cell in accordance with an embodiment of the present invention;

FIG. 2 illustrates an example of a multi-casting data transmission using a per-stream power control in accordance with an embodiment of the present invention;

FIG. 3 illustrates an example of a multi-casting data transmission using a MU-MIMO method in accordance with an embodiment of the present invention;

FIG. 4 is a detailed block diagram of an AP in accordance with an embodiment of the present invention; and

FIG. 5 is a control flow diagram illustrating a process for a downlink multicasting using a station grouping in accordance with an embodiment of the present invention.

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

In an actual WLAN scenario of an example, all of the stations within one cell are non-uniformly distributed around an AP (Access Point). In this situation, some of the stations are located far away from the AP and hence has a low SNR value. On the other hand, some of the stations are located very closely to the AP and hence has excellent signal strength. As well known in the art, a signal level that is received directly affects the modulation and coding scheme (MCS) selected for data transmission. The lower SNR is, the slower data transmission rate is selected. This is because low physical transmission rate is more robust and error resilient.

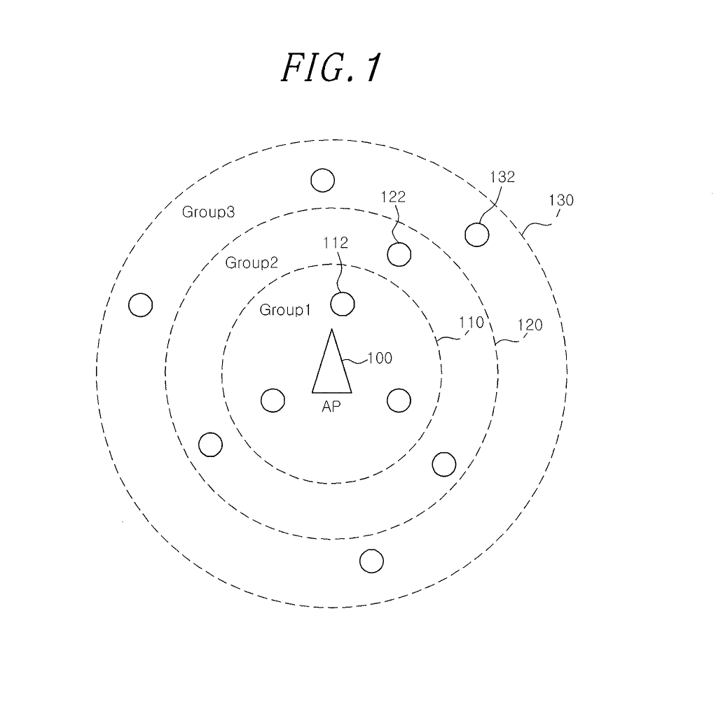

If a multicasting becomes possible as described in the scenario, then the stations with good signal level suffer longer delay. FIG. 1 is a diagram of an example of illustrating the distribution of stations in a cell. When an AP 100 transmits downlink multicast traffic in consideration of the transmission rate for the stations in a third group 130, all the stations achieve the same amount of throughput and use the same amount of service time. However, this is unfair to the stations in a first group 110 and a second group 120. The reason is that the stations in the first group 110 and the second group 120 may receive much more data within the same amount of time. Furthermore, the fairness among the stations needs only to consider the channel occupancy time.

Therefore, in order to fully take an advantage of the MU-MIMO technique, the embodiment of the present invention proposes a technique of a per-stream power control and a station grouping.

Since the AP always monitors the SNR values of the respective multicast receivers, the AP is able to classify the stations, which are equivalent to the multicast receivers, into several subgroups. The number of subgroups that are classified by the AP depends on the number of transmitting and receiving antennas at the AP and the stations. In other words, the number of multicast subgroups is the total number of simultaneous data streams that can be supported. In this embodiment, the term “multicast subgroup” is used, on the ground that there may be several multicast groups in a single cell and these groups are further divided into subgroups depending on the received SNR values.

Referring now to FIG. 1 that shows an example of the station grouping, the stations in the first group 110 have a very high SNR value. Meanwhile, the stations in the second group 120 have a smaller SNR, and the stations in the third group 130 shows a very poor channel condition as compared with the first group 110 and the second group 120.

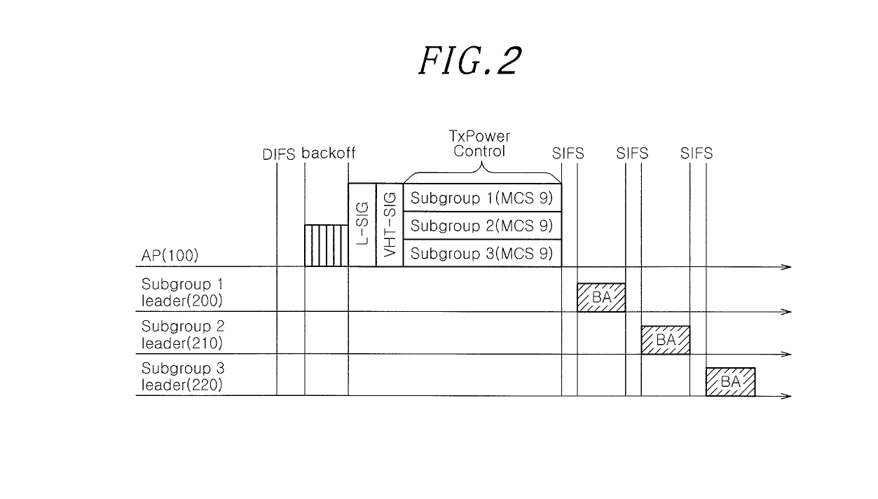

FIG. 2 illustrates an example of a multicasting using a per-stream power control in accordance with an embodiment of the present invention.

Referring to FIG. 2, even though the stations are unevenly distributed across the cell, by adjusting the transmission power for each different stream, the AP 100 may transmit multicasting data for each subgroup such as a first subgroup, a second subgroup, a third subgroup using the same high MCS value. In the embodiment, a leader is assigned for each subgroup, e.g., the first subgroup, second subgroup, and third subgroup. The stations that are assigned as the leader in the respective subgroups, i.e., a leader 200 in the first subgroup, a reader 210 in the second subgroup and a reader 220 in the third subgroup, serves to transmit a block acknowledgement (BA). On the other hand, since the maximum transmission power level is limited due to the regulation, the maximum transmission power level cannot be always increased. In addition, some interference problems may arise. In this case, it is necessary to apply certain measurements for transmission rate adaptation.

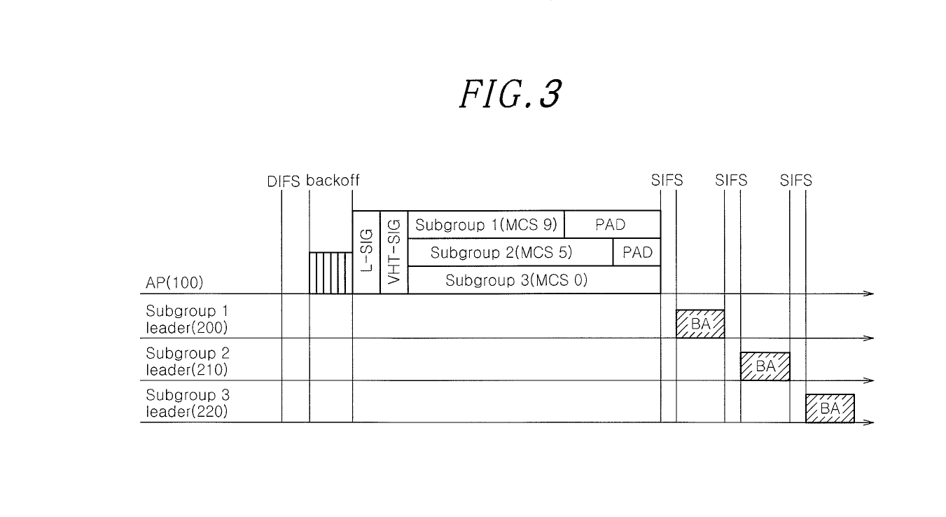

FIG. 3 illustrates an example of a multicasting data transmission when applying a station grouping in accordance with an embodiment of the present invention.

After accessing a channel, the AP 100 forms different A-MPDU for each group of users. Each of the A-MPDU is simultaneously transmitted to its corresponding multicast subgroup using a selected MCS. At this time, a leader is assigned for each subgroup of the first subgroup, second subgroup, or third subgroup; and the stations that are assigned as leaders in the respective subgroups, i.e., a leader 200 in the first subgroup, a reader 210 in the second subgroup and a reader 220 in the third subgroup, serve to transmit a block acknowledgement (BA). Specifically, each leader 200, 210, 230 transmits a BA which validates the successful or erroneous reception for different A-MPDUs. In order to avoid collisions between the BAs from the respective leaders, the AP 100 specifies the order in which each leader will respond.

In comparison with the example in FIG. 3, it takes less time for the example in FIG. 2 to transmit the same amount of data due to the smart power allocation among different streams. As described above, the AP 100 classifies the stations into subgroups, and then applies a per-stream transmit power control and selects an appropriate MCS for each subgroup, which results in improving the overall network performance.

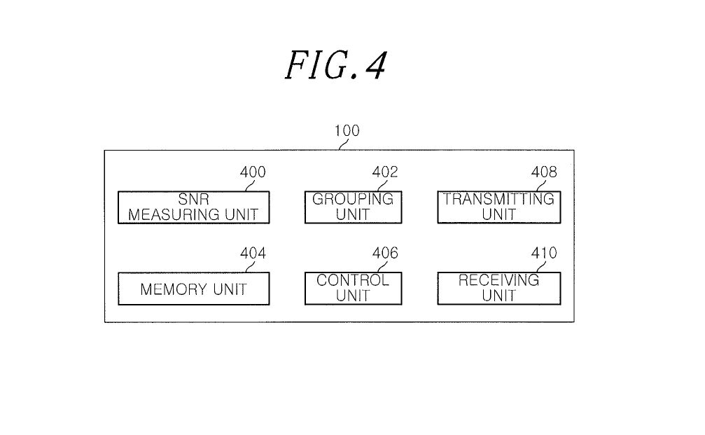

FIG. 4 is a detailed block diagram of the AP in accordance with an embodiment of the present invention. The AP 100 includes an SNR measuring unit 400, a grouping unit 402, a memory unit 404, a control unit 406, a transmitting unit 408, and a receiving unit 410.

Hereinafter, the operation of the respective components of will be described in detail with reference to FIG. 4.

First, the SNR measuring unit 400 measures the SNR of the stations that exist in the multi-transmission environment.

The grouping unit 402 groups the stations into plural subgroups using the SNR values of the stations that are measured in the SNR measuring unit 400. The subgroups may be classified into, for example, three subgroups including a first subgroup, a second subgroup, and a third subgroup, which is merely an illustrative example and may be classified into any number of subgroups as needed.

Further, the grouping unit 402 determines stations, which will be a leader, among the stations in the respective subgroup that are grouped as described above taking account of the SNR values of the stations. In this case, in determining the stations as a reader, the grouping unit 402 may determine the stations with the lowest SNR value in each subgroup as the leader.

The control unit 406 controls the overall operations of the AP 100 based on the operation program stored in the memory unit 404. Further, the control unit 406 determines an MCS to be applied for each of the subgroups and forms an A-MPDU for the transmission to each subgroup in accordance with an embodiment of the present invention. At this time, the control unit may form different A-MPDU for each subgroup. After forming the A-MPDU for each subgroup, the control unit 406 multicast-transmits the A-MPDU for each subgroup to the stations in the subgroup via the transmitting unit 408.

Further, the control unit 406 may able to transmit the transmission power on a stream basis dissimilarly during the transmission of the A-MPDU for each subgroup, and may adjust the size of the different A-MPDU for each subgroup such that the transmission of the different A-MPDU for each subgroup is completed at the same time.

The receiving unit 410 receives BAs that are transmitted from the stations having received the A-MPDUs and provides the BAs to the control unit 406.

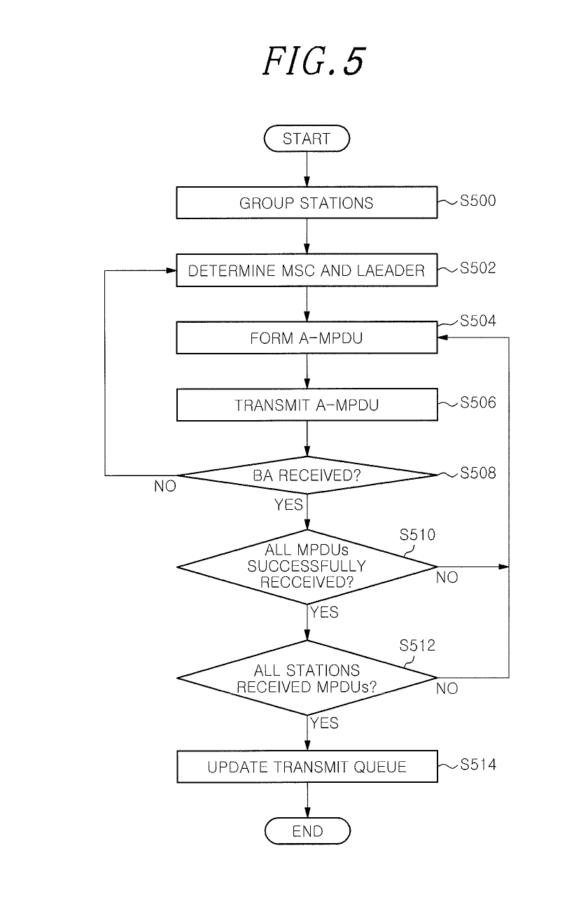

FIG. 5 is a control flow diagram illustrating a process for a downlink multicasting transmission in accordance with an embodiment of the present invention. Hereinafter, the operation of the exemplary embodiment of the present invention will be described with reference to FIGS. 1 to 5.

First, the AP 100 classifies the stations 112, 122, 132 in each group into several subgroups in an operation 5500. Further, the AP 100 determines an appropriate MCS for each subgroup and determines a leader of each subgroup in an operation 5502. The determination may be made through link quality information between the AP 100 and each station.

After that, the AP 100 defines a threshold of a signal quality level, e.g., an SNR for each of the subgroups. The stations may be assigned to their corresponding subgroups considering the thresholds. The AP 100 may also select a leader in each subgroup. In the selection of the leader, a station, for example, with the worst link quality level within a subgroup may be selected as the leader. In addition, the MCS selection may be done by monitoring the SNR of the leader or any other rate adaptation algorithm.

The AP 100 has to form a different A-MPDU for each subgroup separately since a higher MCS allows more MPDUs to be aggregated for the stations with a high SNR compared to the stations with a low SNR in an operation 5504. The AP 100 forms the A-MPDU such that the transmission of each A-MPDU is completed at the same time. It requires adjusting a size of A-MPDU and, therefore, the AP 100 may introduce a frame padding (PAD) in order to correctly adjust the size of A-MPDU.

After each A-MPDU is created, the AP 100 attaches a common physical protocol data unit (PPDU) header and transmits A-MPDUs with the header by using different transmission rates in an operation S506.

Each station receives the A-MPDU and verifies the correctness of reception of the A-MPDU by using a CRC field. For the leader station, after receiving the A-MPDU, it replies with a BA specifying which frame must be retransmitted. If all of the A-MPDUs are received correctly, then the BA just verifies the successful reception. In case of each non-leader station, if every A-MPDU is received correctly, it remains silent.

If, however, some of the A-MPDUs are not received correctly, the non-leader stations send a negative ACK (NACK) which is dummy data. This NACK may cause a collision with the BA transmitted by the leader, which hinders the proper reception of the BA.

As such, when it is determined that the BA is not received correctly from the stations in an operation S508, the AP 100 starts a new leader selection procedure as in the operations 5502 to S506. During the leader selection procedure, the AP 100 sends a leader selection request message causing each of the station within a subgroup sequentially to reply with a BA. This BA acknowledges the reception of the latest A-MPDU indicating which MPDUs must be included in a new A-MPDU. This allows eliminating unnecessary duplicate transmission of some MPDUs. This procedure is repeated until the AP correctly receives BA from the leader.

Meanwhile, when it is determined that the BA is successfully received from the stations in an operation S508, the AP 100 checks whether the A-MPDUs are received from all of the stations correctly, in an operation 5510.

In case where the AP 100 receives the BAs which indicate that some of the A-MPDUs but not all of them are received correctly, then it means only the leader did not receive some of the A-MPDUs. In such a case, the AP 100 forms a new A-MPDU and initiates re-transmission. To increase the efficiency, the AP 100 may also include new MPDUs into the retransmitted A-MPDU if there are available frames in the transmit queue.

However, when the AP 100 successfully receives the BAs indicating the successful reception of all A-MPDUs in the operation S510, the AP 100 further checks whether the MPDUs are correctly received by the multicast receivers, i.e., the stations, in other subgroups in an operation 5512.

When it is checked that the A-MPDUs are correctly received by the entire multicast receiver in the other subgroups in the operation 5512, the AP 100 updates the transmit queue in an operation 5514. Those A-MPDUs that are correctly received by the entire multicast receivers in all the subgroups can be removed from the transmit queue through the update procedure. If all frames are received correctly, then there is no need to initiate a new leader selection procedure and the transmission can proceed with the memberships in the same subgroup and the leaders.

As described above, the embodiment of the present invention proposes a station grouping in a multi-transmission environment of a TDMA/MU-MIMO system wherein the grouping of the multicast receivers is made depending on the channel quality and a per-stream transmission power control and an appropriate MCS for each individual subgroup are employed. Accordingly, it is possible to increase the efficiency of a downlink frame multicasting in MU-MIMO wireless WLAN environment based on the multicasting and keep the fairness among the multicast receivers at high level.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for grouping a plurality of stations in a multi-transmission environment, the apparatus comprising:
an SNR (Signal to Noise Ratio) measuring unit configured to measure SNR values of the stations existing in the multi-transmission environment;
a grouping unit configured to group the stations into several subgroups depending on the SNR values, wherein a leader is defined in each subgroup; and
a control unit configured to determine an MCS (Modulation and Coding Scheme) intended for each subgroup and form different A-MPDU (Aggregated MAC Protocol Data Unit) for each subgroup separately to send to each subgroup in a multicast transmission.

2. The apparatus of claim 1, wherein the grouping unit is configured to determine the leader as a station, among the stations in each subgroup, with the lowest SNR in the subgroup.

3. The apparatus of claim 1, wherein the control unit is configured to determine the MCS that will be applied to the subgroup considering the SNR value of the leader station in the subgroup.

4. The apparatus of claim 1, wherein the control unit is configured to adjust a size of the different A-MPDU for each subgroup such that the transmission of the different A-MPDU is completed at the same time.

5. The apparatus of claim 1, wherein the control unit is configured to adjust a different transmission power on a stream basis separately for each subgroup when transmitting the A-MPDU to the subgroup.

6. A method for grouping a plurality of user stations in a multi-transmission environment, the method comprising:
grouping the stations existing in the multi-transmission environment into several subgroups depending on SNR values that are measured from the respective stations;
determining an MCS (Modulation and Coding Scheme) intended for each subgroup;
defining a station that becomes a leader of each subgroup; and
forming a different A-MPDU (Aggregated MAC Protocol Data Unit) to be transmitted to each subgroup separately such that the different A-MPDU in line with a link quality of the each subgroup; and
multicast-transmitting the A-MPDU to the stations in its corresponding subgroup.

7. The method of claim 6, wherein the different A-MPDU is adjusted in its size such that the transmission of the different A-MPDU for each subgroup is completed at the same time.

8. The method of claim 6, wherein said determining the MCS comprises: determining the MCS that is applied to the subgroup considering the SNR value of the leader station of in the subgroup.

9. The method of claim 6, wherein said defining the station that becomes the leader comprises:
comparing SNR values of the stations in each subgroup; and
selecting a station with a lowest SNR value as the leader.

10. The method of claim 6, further comprising:
checking whether a BA (block acknowledgement) is received from the leader station in each subgroup; and
defining a leader of the subgroup again when it is checked that the BA is not received.

11. The method of claim 10, further comprising:
when it is checked that the BA is received, checking whether all the stations in the subgroup successfully receive the A-MPDU; and
when it is checked that all the stations do not receive the MPDU successfully, forming a new A-MPDU of the subgroup.

12. The method of claim 6, further comprising:
when it is checked that a successful reception of all A-MPDUs is made, removing the A-MDPUs in a transmit queue that are waiting to transmit to the subgroups.
